(19) United States
(12) Patent Application Publication
(10) Pub. No.: US 2024/0210674 A1
(43) Pub. Date: Jun. 27, 2024

(54) ANTIFOULING SYSTEM, CONFIGURED TO BE TRANSFERRED TO A MEASURING DEVICE

(71) Applicant: COMMISSARIAT A L'ENERGIE ATOMIQUE ET AUX ENERGIES ALTERNATIVES, Paris (FR)

(72) Inventor: Fabrice CASSET, Grenoble Cedex 09 (FR)

(73) Assignee: COMMISSARIAT A L'ENERGIE ATOMIQUE ET AUX ENERGIES ALTERNATIVES, Paris (FR)

(21) Appl. No.: 18/543,964

(22) Filed: Dec. 18, 2023

(30) Foreign Application Priority Data
Dec. 22, 2022 (FR) 22 14324

(51) Int. Cl. G02B 27/00

(52) U.S. Cl. CPC G02B 27/0006

(57) ABSTRACT

A system configured to be transferred to a measuring device configured to be immersed in a liquid at a pressure P_{liquid} and which includes a surface sensitive to biofouling; it is designed to cover the sensitive surface and includes a plate able to vibrate, having a front face and a rear face, one of which is configured to be in contact with the liquid; an actuator, located on one of the faces, able to make the plate vibrate, to limit the attachment of micro-organisms to the plate; a closed cavity, delimited at least partly by the rear face, and which is filled with a fluid at a pressure P_{cavity}; a fluid compressor, in fluid communication with the closed cavity, able to modulate the pressure P_{cavity} in the cavity, so that the difference between the pressures on the front and rear faces is less than 2 bar.

### TECHNICAL FIELD

The field of the invention is that of so-called “antifouling” systems configured to be fitted to measuring devices (in particular optical measuring devices) immersed in a liquid medium, in particular sensors and measuring probes.

### PRIOR ART

Various sensors are used in liquid medium to control the properties of the medium (pH probe, density, etc.) or measure various characteristics such as turbidity, the presence of chemical species or certain bacterial strains, etc.

These sensors can be used in an industrial environment (tanks, pipes) or natural environment (sea, oceans, rivers, etc.). In this way, millions of immersed sensors are used in liquid medium.

However, any surface immersed in a liquid, whether it is freshwater or seawater, is prone to the deposition and adhesion of organisms, which may be bacteria, algae, molluscs, etc. This phenomenon is known as biofouling. The adhesion of micro-organisms to materials and their multiplication results in the formation of a film (known as biofilm) on the surface of the immersed materials after only a few minutes of immersion.

This phenomenon of biofouling is problematic in the field of sensors as it can often have an impact on the measurements taken by these sensors in a liquid medium.

We can take the example of optical sensors, which use an optical beam to control a property of the liquid medium, for example turbidity. Biofouling on the optical window (or porthole) of the optical sensor will have an impact on the passage of the beam, impairing the measurement to the point where it becomes impossible.

According to another example, in the case of a biological sensor designed to detect the specific adhesion of desired agents to the surface of a functionalization layer, the presence of biofouling will make it impossible for the desired target to reach the functionalization layer; the sensor will therefore no longer function at all, or worse, will give false positive alert results.

It is readily understood that so-called “antifouling” solutions designed to combat the biofouling of sensors are necessary to obtain consistent data quality from the sensors and to reduce the maintenance required to clean them.

One of the known solutions is the applicant's antifouling device, which is described in patent application FR 3 106 211 and is designed to be fitted to a measuring system configured to be immersed.

As shown in FIG. 1, a measuring device 10 (for example an optical sensor), which has a surface sensitive to fouling (in other words, which is prone to fouling or likely to be contaminated by micro-organisms), is equipped with an antifouling system 20. This antifouling system 20 has:
a plate 110 able to vibrate;
holding means 12, designed to hold the plate 110 above the sensitive surface 7 of the measuring device 10 (for example, the sensitive surface can be an optical window), a rear face of the plate facing the sensitive surface;
at least one actuator 22 able to make the plate 110 vibrate, so as to generate an acoustic wave able to at least limit the attachment of micro-organisms to the sensitive surface.

In a known way, a control unit CU (not shown) is designed to control said actuator to make the plate vibrate.

FIG. 2 is a top view of this system from the prior art. It shows that the measuring device 10 is cylindrical and the plate is rectangular. The holding means 12 that hold the plate above the sensitive surface 7 can be bars.

In this design, the liquid in which the assembly made up of the measuring device 10 and the antifouling system 20 is immersed circulates between the device 10 and the antifouling system 20. The acoustic wave generated by the vibrating plate will propagate through the liquid and, upon reaching the sensitive surface 7, limit or prevent the biofouling of this sensitive surface.

In this way, in this prior art, it is the acoustic wave generated by the vibrating plate that will cause the antifouling effect. But the vibrating plate can be fragile. For more robustness and efficiency and a more compact design, the inventors have envisaged the holding means being a single element which, with the sensitive surface 7 of the measuring device 10 and the plate 110, delimit a closed space (or closed cavity).

In this specific case, the front face of the plate is configured to be in contact with the liquid and the rear face is located on the side of the measuring device 10. The plate 110 therefore has, on either side, two media which can have very different pressures: on the measuring device side, the pressure is atmospheric pressure, whereas on the liquid side, the pressure is the pressure of the liquid (for example, of the water), which increases with depth.

The limits of such an assembly are therefore understood: the plate has to be flexible to allow high vibration amplitudes and, therefore, cannot withstand the high pressures caused by immersion at depth or in a pressurized liquid medium.

The inventors have therefore striven to design an antifouling system that can be fitted to a measuring device, by isolating the sensitive surface of the device, such that the assembly formed in this way can operate whilst immersed at depth and/or in a pressurized liquid.

### DESCRIPTION OF THE INVENTION

To do this, the invention relates to a system for combating biofouling by micro-organisms, configured to be transferred to a measuring device which is configured to be immersed in a liquid at a pressure P_{liquid} and which comprises a surface sensitive to biofouling, the system being designed to cover the sensitive surface,

the system comprising:
a plate able to vibrate, having two opposite main faces, known as the front face and rear face, the front face being configured to be in contact with the liquid; and
at least one actuator, located on one of the main faces of the plate, able to make the plate vibrate, so as to at least limit the attachment of micro-organisms to the plate;
   the system being characterized in that it also comprises:
a closed cavity, which is delimited at least partly by the rear face of the plate, and which is filled with a fluid at a pressure P_{cavity}; and
a fluid compressor, in fluid communication with the closed cavity, able to modulate the fluid pressure P_{cavity} in the cavity, such that the absolute value of the difference between the pressure P_{liquid} on the front face and the pressure P_{cavity} on the rear face is less than 2·10⁵ Pa (2 bar), preferably less than 5·10⁴ Pa (0.5 bar), ideally the pressures are equal. Indeed, the compressor is preferably able to modulate the pressure in the cavity P_{cavity} such that it is equal to the pressure of the liquid P_{liquid}.

The plate is preferably a membrane. “Membrane” is understood to mean a structure with a small thickness compared to its planar dimensions. It should be noted that in the case of an embedded membrane, it will be considered at its perimeter.

The actuator is preferably located on the rear face of the plate.

The fluid compressor is preferably an air compressor. For example, a compressor manufactured by Fluigent or Würth can be used.

The closed cavity preferably has a depth, in a direction perpendicular to the rear face of the plate, comprised between 1 and 10 mm, including the limits. This depth is preferably equal to 1 mm.

Advantageously, the sensitive surface can be an optical window, for example when the measuring device is an optical measuring device. “Optical window” is understood to mean the zone through which the optical signal will pass on its way from the optical measuring device to the medium to be characterized.

According to another variant, the sensitive surface can be a functionalization layer, when the measuring device is a biological sensor designed to detect the specific adhesion of desired agents to the surface of the functionalization layer.

The measuring device can, for example, be an optical sensor or an optical probe.

The actuator can be a piezoelectric, ferroelectric, electrostatic, magnetic or thermal actuator.

The invention also relates to an assembly according to a first variant, comprising a measuring device and a system for combating biofouling as described above, wherein the cavity is arranged in contact with the entire sensitive surface, the sensitive surface and the plate facing each other.

The measuring device is preferably arranged inside a protective housing (for example an enclosure), the system for combating biofouling being used to close and seal the housing, the cavity, and possibly the fluid compressor of the system, being arranged inside the housing.

The invention also relates to an assembly according to a second variant, comprising a measuring device and a system for combating biofouling as described above, wherein the cavity is arranged at a distance from the sensitive surface, the sensitive surface and the plate facing each other, the system for combating biofouling being used to close and seal the housing, the cavity, and possibly the fluid compressor of the system, being arranged inside the housing.

### BRIEF DESCRIPTION OF THE DRAWINGS

Other features and advantages of the invention will become apparent from the following description provided by way of non-limiting example with reference to the appended figures in which:

FIG. 1, already described above, is a schematic side-view representation of an assembly from the prior art comprising a measuring device having a surface sensitive to biofouling, which is equipped with an antifouling system;

FIG. 2 is a top view of the assembly from the prior art shown in FIG. 1;

FIG. 3 is a schematic cross-sectional view from the side of an exemplary antifouling system according to the invention;

FIG. 4 is a schematic cross-sectional view of an exemplary antifouling system according to the invention, integrated into the sensitive surface of a measuring device;

FIG. 5 is a schematic cross-sectional view of another exemplary antifouling system according to the invention, integrated into the sensitive surface of a measuring device, all inserted in a housing;

FIG. 6a is a schematic cross-sectional representation of a first step of an exemplary embodiment of an antifouling system according to the invention;

FIG. 6b is a schematic cross-sectional representation of a second step of an exemplary embodiment of an antifouling system according to the invention;

FIG. 6c is a schematic cross-sectional representation of a third step of an exemplary embodiment of an antifouling system according to the invention;

FIG. 6d is a schematic cross-sectional representation of a fourth step of an exemplary embodiment of an antifouling system according to the invention;

FIG. 6e is a schematic cross-sectional representation of a fifth step of an exemplary embodiment of an antifouling system according to the invention;

FIG. 6f is a schematic cross-sectional representation of a sixth step of an exemplary embodiment of an antifouling system according to the invention;

FIG. 6g is a schematic cross-sectional representation of a seventh step of an exemplary embodiment of an antifouling system according to the invention;

FIG. 6h is a schematic cross-sectional representation of an eighth step of an exemplary embodiment of an antifouling system according to the invention;

FIG. 6i is a schematic cross-sectional representation of a ninth step of an exemplary embodiment of an antifouling system according to the invention;

FIG. 6j is a schematic cross-sectional representation of a tenth step of an exemplary embodiment of an antifouling system according to the invention.

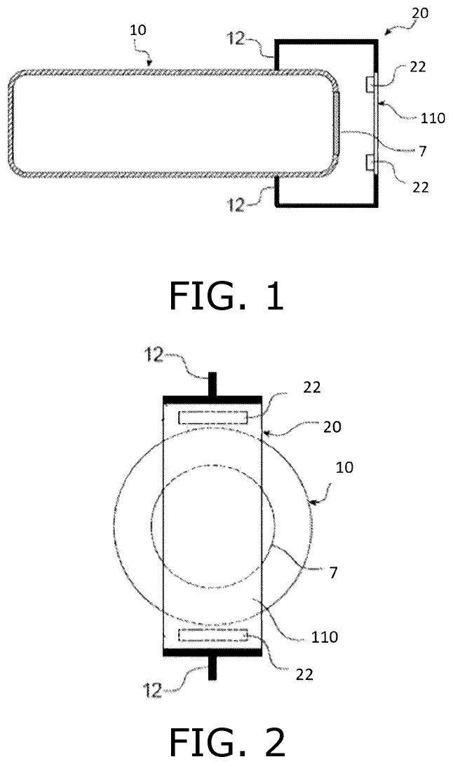

### DETAILED DESCRIPTION OF PARTICULAR EMBODIMENTS

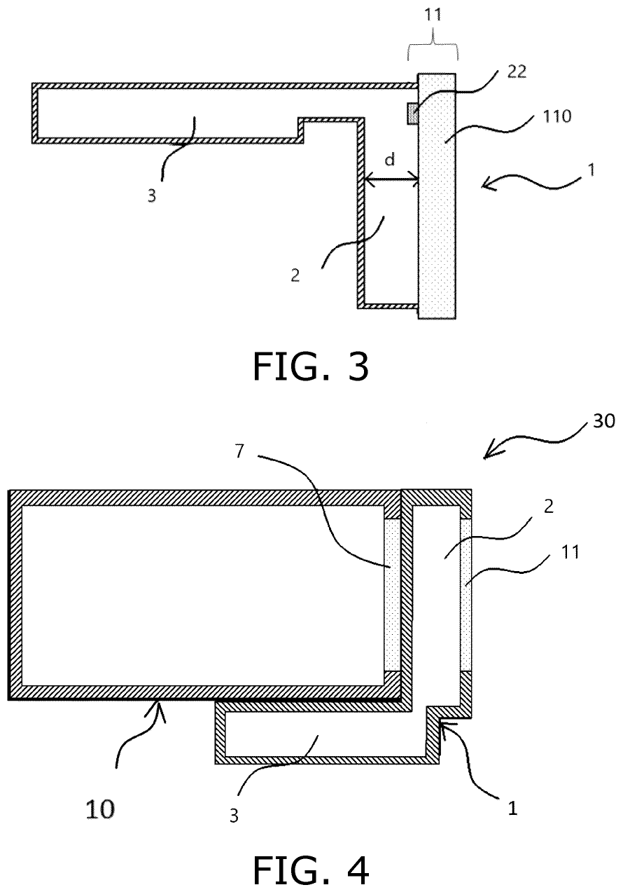

An exemplary embodiment of an antifouling system 1 according to the invention is shown in FIG. 3. The system 1 comprises a plate 110 able to vibrate, having a front face and a rear face, the front face being configured to be in contact with the liquid; an actuator 22, which is located here on the rear face of the plate; the plate 110 and actuator 22 assembly is labelled with reference number 11; a closed cavity 2, which is delimited at least partly by the rear face of the plate 110, and which is filled with a fluid at a pressure P_{cavity}; and a fluid compressor 3, which is in fluid communication with the closed cavity 2. The fluid compressor is able to modulate the fluid pressure P_{cavity} in the cavity, such that the absolute value of the difference between the pressure P_{liquid} on the front face and the pressure P_{cavity} on the rear face is less than 2 bar, preferably 0.5 bar, ideally the pressures are equal.

The cavity 2 of the antifouling system 1 can be arranged at a distance from the sensitive surface 7, and in this case the cavity and the measuring device with the sensitive surface have to be placed in a protective housing 4 so that the sensitive surface, despite this distance, is protected.

The cavity 2 of the antifouling system 1 is preferably configured to be arranged in contact with at least part of the sensitive surface 7 (preferably with all of the sensitive surface) of a measuring device 10, the sensitive surface 7 and the plate (membrane) 110 being configured to face one another, the combination of the measuring device 10 and the system for combating biofouling 1 forming an assembly 30. For example, the sensitive surface 7 can be the optical window of an optical measuring device (for example an optical sensor type).

An exemplary embodiment of an assembly 30 according to the invention is shown in FIG. 4. It should be noted that, for the sake of simplicity, we have not provided the same level of detail as in FIG. 3 to represent the plate 110 and the actuator 22, and we have only used reference number 11 to designate all of these elements.

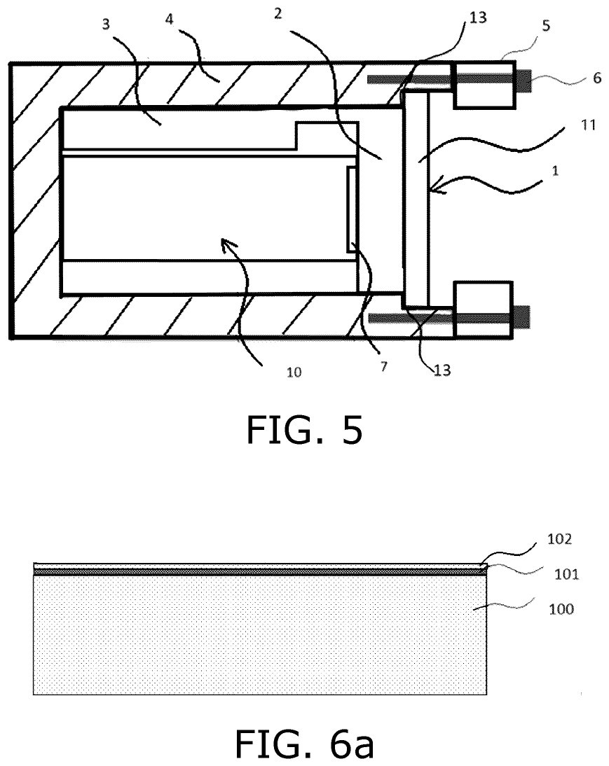

According to another exemplary embodiment shown in FIG. 5, the measuring device 10 can be arranged inside a protective housing 4, the system for combating biofouling 1 being used to close and seal the housing, the cavity 2 and the fluid compressor 3 of the system 1 being arranged inside the housing 4. In FIG. 5, the housing has a recess 13 at its opening delimiting an inner shoulder on which the system 1 for combating antifouling rests. Fixing elements, such as nuts 5 and screws 6, are then used to fix the system 1 to the housing 4 and thus to close and seal it. This type of housing enables the antifouling system to be integrated into the measuring device, but any other type of integration bringing together the antifouling system, the cavity able to equalize the pressures and the measuring device can also be used.

In the assembly 30 according to the invention, the system 1 for combating fouling can be adapted to the pressure of the liquid in which it is immersed. The system for combating fouling can thus withstand high liquid, for example water, pressures, in particular when immersed in very deep water.

Thanks to the presence of the cavity on the rear face of the plate and the compressor, which is connected to the cavity, the pressure on the rear face of the plate can be adjusted so as to equalize the pressures on either side of the plate. The pressure of the fluid inside the cavity, for example air, Pₐᵢᵣ and the pressure of the liquid in which the assembly is immersed, for example water, P_{water}, balance out, and the vibrating plate can operate without being hindered by a potentially large pressure difference. It should be noted that we are providing the example of using air in the cavity, but any gaseous or liquid fluid that would not cause biofouling in the cavity could be considered.

In the antifouling system 1 according to the invention, the cavity 2 on the rear face of the plate 110 extends over at least the entire surface of the rear face of the plate able to vibrate. This therefore provides an indication of the width, length and diameter of the cavity. The depth d of this cavity must be small enough to allow potentially high pressures to be easily obtained (for example 5·10⁷ Pa (500 bar) at a depth of 5,000 m), but large enough so that the plate does not strike the bottom of the cavity when it resonates.

For example, when the plate is a membrane with a diameter of 2 centimetres and having deformation amplitudes of several micrometres, of the order of 15 μm to 50 μm, a minimum cavity depth d=100 μm is required. Due to integration constraints, a value for d of the order of 1 to 10 mm, including the limits, will be chosen, but it is perfectly possible to have a deeper cavity; for example, it is possible to have a cavity, the depth of which corresponds to the depth of the body of the measuring device 10.

By design, the internal pressure Pᵢₙₜ in the cavity (and therefore at the rear face of the plate) is equal to the atmospheric pressure (Pₐₜₘ).

When the assembly made up of the measuring device 10 and the antifouling system 1 is immersed in a liquid, the pressure Pₑₓₜ at the front face of the plate, as a function of the immersion depth h (in metres) of the plate, is known and follows the following law:

Pₑₓₜ=Pᵢₙₜ+0.1×h≈1+0.1×h

In the antifouling system according to the invention, a compressor is used to adjust Pᵢₙₜ to the immersion depth, and thus to Pₑₓₜ. The adjustment is carried out such that the absolute value of the difference between Pᵢₙₜ and Pₑₓₜ is less than or equal to 2·10⁵ Pa (2 bar), or better still, less than 5·10⁴ Pa (0.5 bar). Pᵢₙₜ and Pₑₓₜ are preferably equal.

The plate can then be operated to create an antifouling effect, without being hindered by a potential pressure difference between the front and rear faces of the plate. It should be noted that the plate can be operated continuously or occasionally (for example before measurements are taken by the measuring device 10).

It should be noted that the pressure in the cavity 2 can be adjusted as a function of the immersion depth, but it can also be adjusted by measuring the pressure of the immersion liquid. Indeed, the antifouling system 1 can integrate a pressure sensor able to measure the pressure of the immersion liquid.

Alternatively, the deformation of the plate can be used to deduce the pressure, prior calibration being necessary.

The plate can be rectangular, square or circular in shape; advantageously, it can be a membrane. By way of example, the plate can be a glass plate, the sides of which can measure, for example, between a few millimetres and a few centimetres.

In a known way, a control unit can be used to command the actuator to make the plate vibrate. This control unit can be configured to control the actuator such that the plate vibrates in its first mechanical vibration mode.

Several actuators can be distributed over the front face and/or the rear face of the plate. In a known manner, the actuator(s) can be chosen from among piezoelectric, ferroelectric, electrostatic, magnetic or thermal actuators.

The actuator(s) is/are preferably positioned on the rear face of the plate, i.e. on the face opposite the face (front face) of the plate configured to be in contact with the immersion liquid.

It should be noted that when the measuring device is an optical measuring device, for example an optical sensor, the plate and the cavity are made of materials that are transparent at the wavelength in question (i.e. they allow at least 90% of the optical beam to pass through). Similarly, the actuator is positioned so as to enable the optical beam to pass through so that the optical beam can reach the sensitive surface.

The antifouling system according to the invention can be produced by a variety of processes; for example, piezoelectric ceramics or thin films of piezoelectric materials (AlN, PZT, LNO, etc.) shaped using microelectronics technologies can be used to produce the actuator(s).

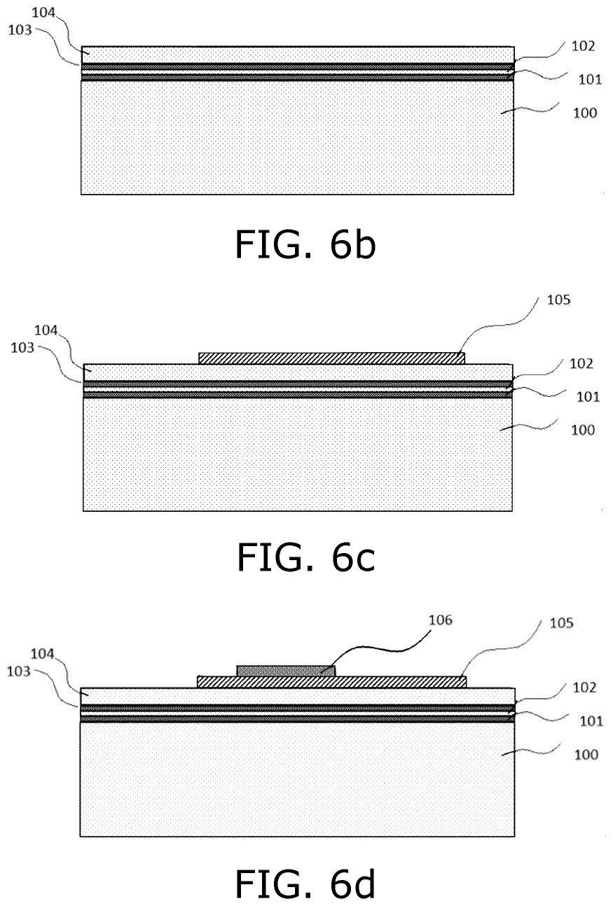

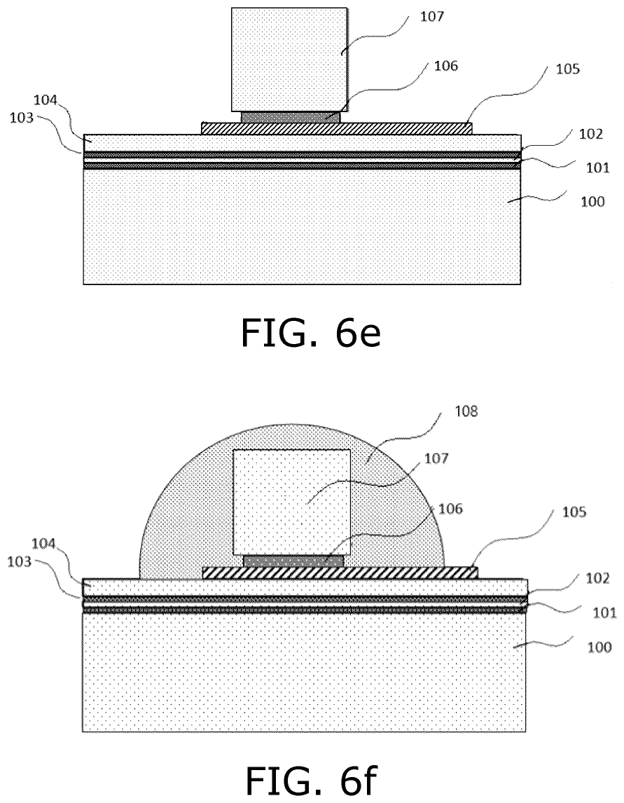

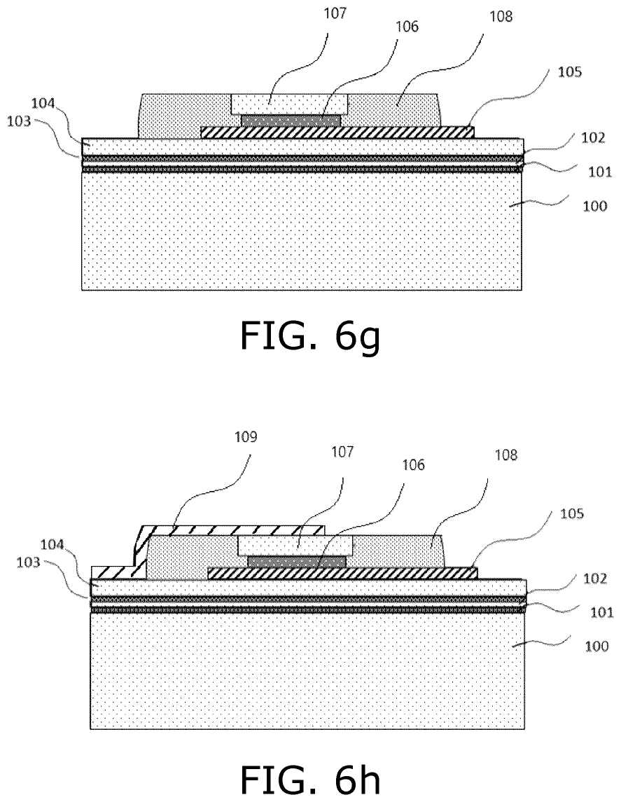

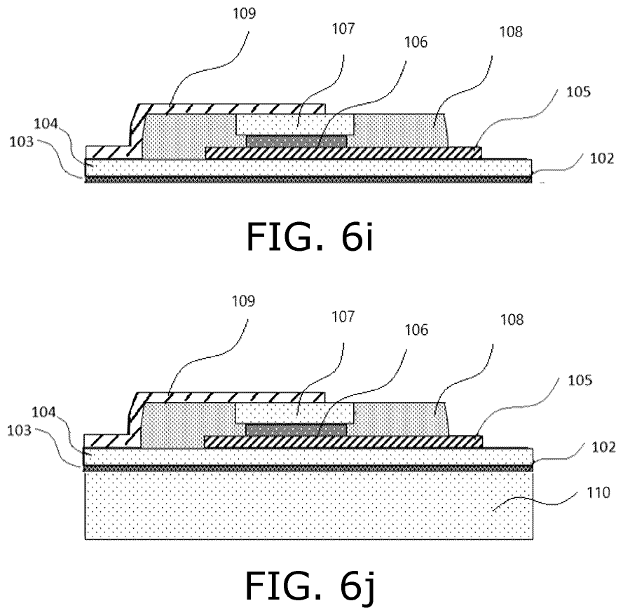

In order to illustrate the invention, we are going to describe an exemplary method for producing an antifouling system according to the invention having a single actuator produced using piezoelectric ceramics (and configured to be located on the rear face of the plate). The steps are shown schematically in FIGS. 6A to 6J.

On one of the main faces (that we will call the front face) of a substrate 100, for example a silicon substrate having a thickness of around 725 μm and a diameter of 200 mm, thermal oxidation is carried out so as to form an oxide layer 101 (SiO₂), for example having a thickness of 500 nm (FIG. 6a).

A layer 102 of platinum and a layer 103 of TEOS (tetraethyl orthosilicate (Si(OCH₂CH₃)₄) are successively deposited on this oxide layer 101, for example by PECVD (Plasma Enhanced Chemical Vapour Deposition). A layer 104 of photosensitive resin, for example an SINR polymer manufactured by Shin-Etsu, is then laminated on (FIG. 6b). For example the Pt/TEOS/SINR layers respectively have a thickness of around 100 nm, 500 nm, 80 μm.

According to another variant (not shown), a titanium layer could also have been deposited before the platinum layer. For example, a Ti/Pt/TEOS/SINR multilayer could have been obtained, the layers respectively having a thickness of around 10 nm, 100 nm, 500 nm, 80 μm.

A piezoelectric actuator is then produced. For this, a layer of gold (Au) of around 500 nm is deposited on a portion of the surface of the SINR layer 104 (FIG. 6c).

As an alternative (not shown), a multilayer comprising a first layer of tungsten W with a thickness of around 50 nm, then a second layer of tungsten nitride alloy (WN) of around 50 nm and finally, a third layer of gold (Au) of around 200 nm could also have been deposited instead of the layer 105. The layers of tungsten and tungsten nitride improve the adhesion of the layer of gold.

Then a layer 106 of conductive adhesive, for example a layer of silver paste is deposited, for example by screen printing (FIG. 6d).

A piezoelectric ceramic block 107 with a thickness of around 250 μm is then deposited on this layer 106 (FIG. 6e). This block 107 will form the body of the piezoelectric actuator and the layers 105 and 109 the upper and lower electrodes, respectively, of the actuator.

This block 107 and part of the layer 105 are then encapsulated by covering them using an encapsulation resin (for example with glob top) to subsequently electrically insulate the electrodes 105 and 109 (FIG. 6f).

This encapsulated block is then levelled until a portion of the piezoelectric ceramic block remains (FIG. 6g). The levelled block portion has a thickness of 90 μm, for example.

A layer 109 that will form the upper electrode of the actuator is deposited on a portion of this levelled block; for this, a layer of gold (Au) of around 500 nm is deposited, for example (FIG. 6h).

As an alternative (not shown), a bilayer could have been deposited to form the upper electrode, for example by depositing a layer of titanium (Ti) of around 20 nm and a layer of gold (Au) of around 500 nm. The layer of titanium is an adhesion layer so that the layer of gold adheres well.

This assembly is then separated into two sub-assemblies by peeling, the separation taking place at the interface between the layer 103 of TEOS and the layer 102 of platinum (FIG. 6i).

The sub-assembly comprising the levelled block forms an actuator 10 and it is glued by its layer 103 of TEOS, for example using a layer of UV glue (not shown), to a plate 8, which is preferably a membrane, for example a polymer sheet, for example made of polycarbonate (FIG. 6j).

To form the cavity 2, the plate fitted with its piezoelectric actuator(s) can be integrated into a housing 4, as described in FIG. 5, ensuring it is sealed and held in place using screws and gaskets. For the sake of readability, the representation of the walls has been simplified in FIG. 5 compared to FIG. 4.

The cavity 2 can be a sub-part of the housing 4, obtained in particular by fixing a transparent wall, for example made of PVC, PC or any other suitable material, into the housing. A hole will enable the passage of fluid from the compressor 3.

The fluid compressor 3, which is in fluid communication with the cavity 2, can be located inside or outside of the housing 4. It is linked to the cavity 2 by a channel or a pipe. The compressor can be, for example, a commercially available compressor, such as a compressor manufactured by Würth.

1. A system for combating biofouling by micro-organisms, configured to be transferred to a measuring device which is configured to be immersed in a liquid at a pressure P_{liquid} and which comprises a sensitive surface sensitive to biofouling, the system being designed to cover the sensitive surface,
the system comprising:
a plate able to vibrate, having two opposite main faces, known as the front face and rear face, the front face being configured to be in contact with the liquid; and
at least one actuator, located on one of the main faces of the plate, able to make the plate vibrate, so as to at least limit the attachment of micro-organisms to the plate;
the system further comprising:
a closed cavity, which is delimited at least partly by the rear face of the plate, and which is filled with a fluid at a pressure P_{cavity}; and
a fluid compressor, in fluid communication with the closed cavity, able to modulate the fluid pressure P_{cavity} in the cavity, such that the absolute value of the difference between the pressure P_{liquid} on the front face and the pressure P_{cavity} on the rear face is less than 2·10⁵ Pa (2 bar), preferably 5·10⁴ Pa (0.5 bar), ideally the pressures are equal.

2. The system of claim 1, wherein the closed cavity has a depth, in a direction perpendicular to the rear face of the plate, comprised between 1 and 10 mm, including the limits.

3. The system of claim 1, wherein the sensitive surface is an optical window.

4. An assembly comprising a measuring device and a system for combating biofouling according to claim 1, wherein the cavity is arranged in contact with the entire sensitive surface, the sensitive surface and the plate facing each other.

5. An assembly comprising a measuring device and a system for combating biofouling according to claim 1, wherein the cavity is arranged in contact with the entire sensitive surface, the sensitive surface and the plate facing each other, the measuring device being arranged inside a protective housing, the system for combating biofouling being configured to close and seal the housing, the cavity, and the fluid compressor of the system, being arranged inside the housing.

6. An assembly comprising a measuring device and a system for combating biofouling according to claim 1, wherein the cavity is arranged at a distance from the sensitive surface, the sensitive surface and the plate facing each other, the system for combating biofouling being configured to close and seal the housing, the cavity, and the fluid compressor of the system, being arranged inside the housing.
